(19) United States
(12) Patent Application Publication
(10) Pub. No.: US 2012/0006145 A1
(43) Pub. Date: Jan. 12, 2012

(54) PEDAL APPARATUS

(75) Inventors: Keisuke Hotta, Chita-gun (JP); Haruhiko Suzuki, Anjo-city (JP); Hidekazu Watanabe, Aichi-gun (JP); Hideto Nebuya, Wako-shi (JP); Toshiichi Terakado, Wako-shi (JP); Kazutaka Maehara, Wako-shi (JP); Tomohiro Sakuraba, Wako-shi (JP)

(73) Assignees: Honda Motor Co., Ltd., Tokyo (JP); Denso Corporation, Kariya-city (JP)

(21) Appl. No.: 13/255,649

(22) PCT Filed: Mar. 9, 2010
(86) PCT No.: PCT/JP2010/054611

§ 371 Date: Sep. 9, 2011

(30) Foreign Application Priority Data
Mar. 11, 2009 (JP) 2009-57742

(51) Int. Cl. G05G 1/30

(52) U.S. Cl. 74/513

(57) ABSTRACT

A friction washer (70, 80, 90) is placed between a housing (10) and a pedal member (20) and exerts a frictional force against rotational movement of the pedal member (20). The friction washer (70, 80, 90) includes at least one displaceable portion (72, 75, 82, 85, 92, 95), which is adapted to be displaced relative to the rest of the friction washer (70, 80, 90) by a predetermined amount in a circumferential direction about a rotational axis (O) of the pedal member (20) upon rotation of the pedal member (20).

### CROSS REFERENCE TO RELATED APPLICATION

This application is based on and incorporates herein by reference Japanese Patent Application No. 2009-57742 filed on Mar. 11, 2009.

### TECHNICAL FIELD

The present invention relates to a pedal apparatus for a vehicle.

### BACKGROUND ART

For instance, in a known accelerator pedal apparatus installed to a vehicle, a pedal member is rotated in a depressing direction by a pedal force, which is a force applied from a foot of a driver (user) against the pedal member. When the pedal force applied against the pedal member is released, the pedal member is rotated in a releasing direction, which is opposite from the depressing direction, by a resilient force of a spring that urges the pedal member in the releasing direction. A rotational angle of the pedal member is sensed with a rotational angle sensor, and a signal, which indicates the sensed rotational angle, is sent from the sensor to an engine control unit (ECU) of an internal combustion engine.

In the drive-by-wire pedal apparatus of the above kind, a frictional force, which limits the rotational movement of the pedal member, is generated with the pedal force of the driver and the resilient force of the spring to obtain predetermined hysteric characteristics, which are in consistent with the amount of rotation (rotational angle) of the pedal member. By implementing the hysteric characteristics, the pedal apparatus provides an appropriate operational feeling to the driver (thereby enabling the driver to keep the pedal operational amount, i.e., the pedal operational angle of the pedal member to a desired value even when the pedal force is slightly varied, i.e., fluctuated).

Japanese Unexamined Patent Publication No. 2001-233080A (corresponding to US 2001/0007206A1) recites a pedal apparatus that includes a friction washer provided between a housing and a spring rotor, which is rotated integrally with the pedal member. The friction washer slides on a wall surface of the spring rotor upon rotation of the pedal member and the spring rotor. With the above construction, when an operational state of the friction washer and the spring rotor is shifted from a static state (i.e., a state where no substantial relative movement occurs between the friction washer and the spring rotor) to a sliding state (Le., a state where the substantial sliding movement occurs between the friction washer and the spring rotor), the pedal force is instantaneously increased due to a difference between a static frictional coefficient and a kinetic frictional coefficient and is then temporarily dropped. Thereafter, the pedal member is rotated and is slipped to cause a slip stroke of the pedal member until the applied pedal force is increased to the pedal force, which is applied at the time of shifting from the static state to the sliding state, once again. Therefore, the output voltage of the sensor is instantaneously increased, and the driver may experience an uncomfortable feeling of abrupt starting (or an uncomfortable feeling of abrupt acceleration) of the vehicle.

Japanese Unexamined Patent Publication No. 2007-213332A (corresponding to US 2007/0180946A1) recites another pedal apparatus, in which a radially outer end part of a friction washer is secured to a housing, and this end part of the friction washer is constructed as a resiliently deformable part, which alleviates a change in the pedal force at the time of starting depression of the pedal member. However, with this construction, when the contact position of the friction washer relative to a pedal rotor or a spring rotor is changed due to a physical change of the friction washer caused by a long term use (or aging) or temperature change, the hysteric characteristics may possibly be varied.

### SUMMARY OF INVENTION

The present invention is made in view of the above disadvantages. Thus, it is an objective of the present invention to provide a pedal apparatus, which implements an improved operational feeling to a user at the time of starting depression of a pedal member.

To achieve the objective of the present invention, there is provided a pedal apparatus, which includes a support member, a pedal member, an urging means and a friction means. The support member is installable to a body of a vehicle. The pedal member is rotatably supported by the support member and is adapted to be depressed in a depressing direction by a driver of the vehicle. The urging means is for urging the pedal member in an opposite rotational direction, which is opposite from the depressing direction of the pedal member. One end part of the urging means is anchored to the support member. The friction means is for applying a frictional force against rotational movement of the pedal member. The friction means is placed between the support member and the pedal member, and at least a portion of the friction means is rotated by a predetermined amount together with the pedal member when the pedal member is rotated.

### BRIEF DESCRIPTION OF DRAWINGS

FIG. 1 is a plan view of a pedal apparatus according to a first embodiment of the present invention;

FIG. 2 is a lateral view of the pedal apparatus of the first embodiment;

FIG. 3 is a cross sectional view taken along line III-III in FIG. 2;

FIG. 4 is a plan view of a friction washer used in the pedal apparatus of the first embodiment;

FIG. 5 is a view taken in a direction of an arrow V in FIG. 4;

FIG. 6 is a view taken in a direction of an arrow VI in FIG. 4;

FIG. 7 is a diagram showing pedal characteristics of the pedal apparatus of the first embodiment;

FIG. 8 is a plan view of a friction washer used in a pedal apparatus according to a second embodiment of the present invention;

FIG. 9 is a view taken in a direction of an arrow IX in FIG. 8;

FIG. 10 is a view taken in a direction of an arrow X in FIG. 8;

FIG. 11 is a cross-sectional view taken along line XI-XI in FIG. 8;

FIG. 12 is a plan view of a friction washer used in a pedal apparatus according to a third embodiment of the present invention;

FIG. 13 is a view taken in a direction of arrow XIII in FIG. 12;

FIG. 14 is a view taken in a direction of arrow XIV in FIG. 12;

FIG. 15 is a cross-sectional view taken along line XV-XV in FIG. 12;

FIG. 16 is rear view of the friction washer of FIG. 12 seen from an opposite side in an axial direction of a rotational axis of a pedal member of the pedal apparatus;

FIG. 17 is a plan view of a friction washer of a pedal apparatus of a first comparative example;

FIG. 18 is a view taken in a direction of XVIII in FIG. 17;

FIG. 19 is a diagram showing pedal characteristics of the pedal apparatus of the first comparative example;

FIG. 20 is a plan view of a friction washer of a pedal apparatus of a second comparative example; and

FIG. 21 is a diagram showing pedal characteristics of the pedal apparatus of the second comparative example.

### DESCRIPTION OF EMBODIMENTS

Various embodiments of the present invention will be described with reference to the accompanying drawings.

### First Embodiment

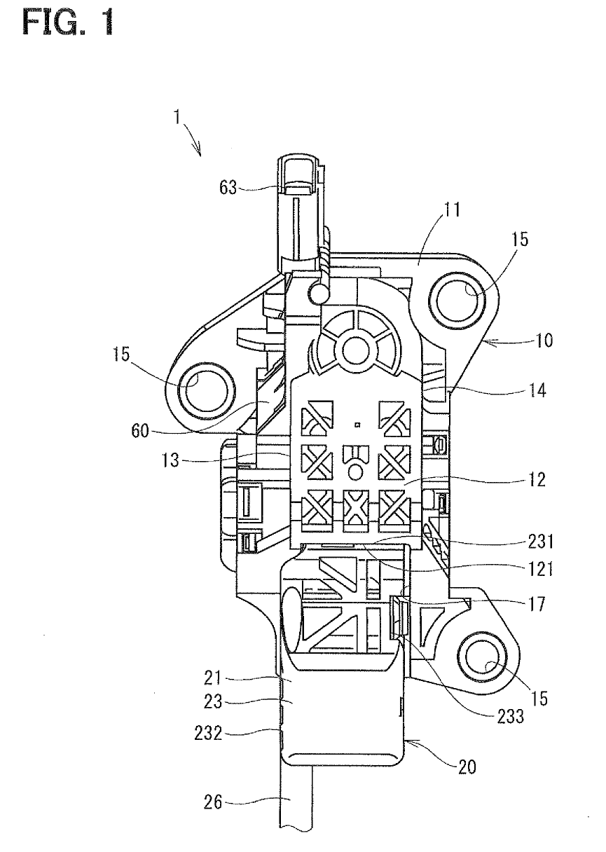

A pedal apparatus according to a first embodiment of the present invention will be described with reference to FIGS. 1 to 7. In the present embodiment, the pedal apparatus is formed as an accelerator pedal apparatus that is installed to a vehicle (e.g., an automobile) and controls a driving state of the vehicle in response to the amount of depression of a pedal member of the pedal apparatus, which is depressed by a foot of a driver of the vehicle. The pedal apparatus is of a drive-by-wire type. A signal, which indicates a rotational angle of the pedal member sensed with a rotational angle sensor, is transmitted to an engine control unit (ECU), which in turn controls a throttle apparatus based on the sensed rotational angle of the pedal member.

As shown in FIGS. 1 to 3, the pedal apparatus 1 includes a housing (serving as a support member) 10, the pedal member 20, a double coil spring (serving as an urging means or an urging device) 50, the rotational angle sensor 60 and a friction washer (serving as a friction means or a friction device) 70.

The housing 10 is configured into a generally box form and includes a bottom plate 11, a top plate 12 and two side plates 13, 14. The top plate 12 is opposed to the bottom plate 11. The side plates 13, 14 are generally perpendicular to the bottom plate 11 and the top plate 12 and are opposed to each other. The bottom plate 11, the top plate 12 and the side plates 13, 14 are integrally molded, i.e., integrally formed from a resin material as a single piece.

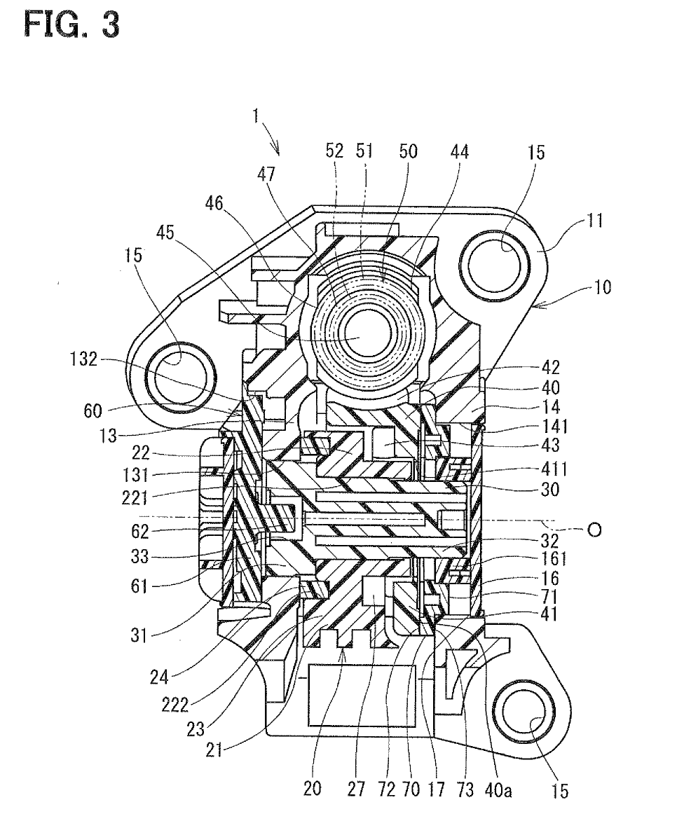

The bottom plate 11 outwardly extends from the side plates 13, 14 and has bolt holes 15, through which bolts are received to securely install the bottom plate 11 to a body of the vehicle with the bolts. The side plate 13 has a bearing hole 131, which is configured into a generally cylindrical form and extends in a plate thickness direction (left-to-right direction in FIG. 3) of the side plate 13, i.e., a direction perpendicular to a plane of the side plate 13. The side plate 14 has a notched hole 141, which extends in a plate thickness direction (left-to-right direction in FIG. 3) of the side plate 14, i.e., a direction perpendicular to a plane of the side plate 14. A bearing member 16 is fitted to an inner peripheral wall of the notched hole 141. The bearing member 16 has a bearing portion 161, which is configured into a generally cylindrical form and projects toward the side plate 13. A center axis of the bearing hole 131 and a center axis of the bearing portion 161 are coaxial with a rotational axis O of the pedal member 20, which will be described later in detail.

The pedal member 20 includes a shaft member 30, a pedal rotor 21, a pedal arm 26 and a spring rotor 40.

The shaft member 30 is configured into a generally cylindrical form and is made of a resin material. One axial end part 31 of the shaft member 30 is rotatably supported by an inner peripheral wall of the bearing hole 131 of the side plate 13. The other axial end part 32 of the shaft member 30 is rotatably supported by an inner peripheral wall of the bearing portion 161.

The pedal rotor 21 includes a rotatable portion 22 and a swingable portion 23. The rotatable portion 22 is configured into a generally cylindrical form. The swingable portion 23 radially outwardly projects from the rotatable portion 22. The rotatable portion 22 and the swingable portion 23 are integrally molded, i.e., integrally formed from a resin material as a single piece.

The rotatable portion 22 includes a large diameter hole 221, which is configured into a generally cylindrical form and extends in an axial direction of the rotational axis O. The shaft member 30 is received through the large diameter hole 221 of the rotatable portion 22. The rotatable portion 22 has a radial ridge, which radially inwardly protrudes into the large diameter hole 221 and is engaged with an undepicted groove, which is formed in an outer peripheral wall of the shaft member 30. Therefore, the pedal rotor 21 and the shaft member 30 are rotated together about the rotational axis O relative to the housing 10 upon rotation of the pedal rotor 21.

An annular groove 222 is formed in one axial end part of the rotatable portion 22, which is adjacent to the side plate 13. A friction ring 24, which is configured into a generally annular form, is press fitted into the annular groove 222. The friction ring 24 slidably contacts an inner wall of the side plate 13.

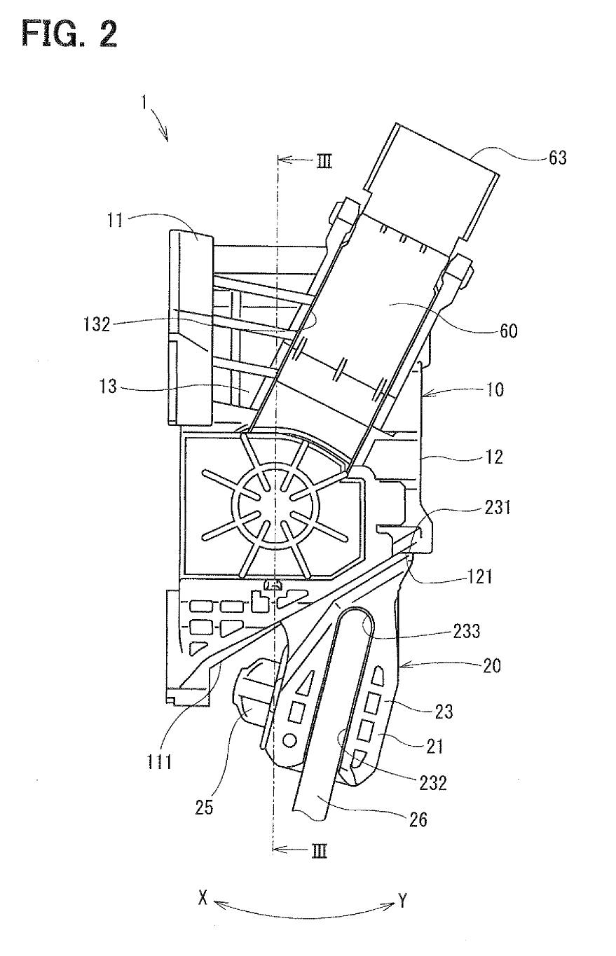

A radial end part of the swingable portion 23, which is opposite from the rotatable portion 22 in the radial direction of the rotatable portion 22 (the radial direction of the rotational axis O), radially outwardly projects from the housing 10 through an opening 17 of the housing 10, which is formed between the side plate 13 and the side plate 14. An engaging portion 231 is provided at one circumferential end part (right end part in FIG. 2) of the swingable portion 23 and is engageable with a stopper 121 of the top plate 12 in the rotational direction (swing direction, pivot direction) of the swingable portion 23 (see double sided arrows X, Y in FIG. 2). A kick-down switch 25 is provided at the other circumferential end part (left end part in FIG. 2) of the swingable portion 23 and is engageable with a stopper 111 of the bottom plate 11 in the rotational direction of the swingable portion 23.

The pedal arm 26 is configured into a rod form and is made of metal. One longitudinal end part of the pedal arm 26 is bent at a generally right angle and is fitted into a groove 232 and a hole 233, which are formed in the swingable portion 23. In this way, the pedal arm 26 is installed to the pedal rotor 21. An undepicted manipulating portion (pedal plate) is provided at the other longitudinal end part of the pedal arm 26 and is adapted to be manipulated with the foot of the driver of the vehicle.

The spring rotor 40 includes a rotor portion 41 and a projection 42. The rotor portion 41 is configured into a generally annular form. The projection 42 radially outwardly projects from the rotor portion 41. The rotor portion 41 and the projection 42 are integrally molded, i.e., integrally formed from a resin material as a single piece.

The rotor portion 41 has a rotational hole (receiving hole) 411, which is configured into a generally cylindrical form and extends in the axial direction of the rotational axis O. The rotor portion 41 is coaxial with the rotatable portion 22. The shaft member 30 is received through the rotational hole 411.

A plurality of bevel teeth 43 is provided at one axial side (left axial side in FIG. 3) of the rotor portion 41, which is adjacent to the pedal rotor 21. The bevel teeth 43 are arranged one after another at generally equal intervals in the circumferential direction of the rotor portion 41 (the rotational direction of the spring rotor 40). A plurality of bevel teeth 27 is provided at one axial side (right axial side in FIG. 3) of the rotatable portion 22, which is adjacent to the rotor portion 41. The bevel teeth 27 are arranged one after another at generally equal intervals in the circumferential direction of the rotatable portion 22 (the rotational direction of the pedal member 20). The bevel teeth 43 of the rotor portion 41 are meshed with, i.e., are engaged with the bevel teeth 27 of the rotatable portion 22, which is opposed to the rotor portion 41 in the axial direction of the rotational axis O. The spring rotor 40 and the pedal rotor 21 are integrally rotated through the engagement between the bevel teeth 43 of the rotor portion 41 and the bevel teeth 27 of the rotatable portion 22.

A holder 44 is configured into a generally circular disk form and is installed to one side (front side of the plane of FIG. 3) of the projection 42, which faces the top plate 12. An undepicted curved convex surface is formed at the one side (front side of the plane of FIG. 3) of the projection 42, at which the holder 44 is installed. The curved convex surface of the projection 42 is convex toward the top plate 12. An undepicted curved concave surface is formed in one side (back side of the plane of FIG. 3) of the holder 44, which is adjacent to the projection 42. The curved concave surface of the holder 44 is concave toward the top plate 12. A radius of curvature of the curved. concave surface of the holder 44 is larger than a radius of curvature of the curved convex surface of the projection 42. The curved convex surface of the projection 42 and the curved concave surface of the holder 44 are engaged with each other in a manner that enables relative movement therebetween.

The holder 44 has a generally spherical protrusion 45, which protrudes from the other side (front side of the plane of FIG. 3) of the holder 44 that is opposite from the curved concave surface, toward the top plate 12. An outer-side annular anchoring surface 46 and an inner-side annular anchoring surface 47 are concentric to each other and are formed radially outward of the protrusion 45.

The double coil spring 50 includes an outer coil spring 51 and an inner coil spring 52. The outer coil spring 51 and the inner coil spring 52 are formed as compression coil springs. One end part of the outer coil spring 51 is anchored to the inner wall of the top plate 12, and the other end part of the outer coil spring 51 is anchored to the outer-side annular anchoring surface 46. One end part of the inner coil spring 52 is anchored to the inner wall of the top plate 12, and the other end part of the inner coil spring 52 is anchored to the inner-side annular anchoring surface 47.

The outer coil spring 51 and the inner coil spring 52 urge the pedal arm 26, the pedal rotor 21 and the spring rotor 40 in the direction of the arrow Y (FIG. 2), which is opposite from the direction of the arrow X, through the holder 44. The projection 42 and the holder 44 are engaged with each other in the manner that enables the relative movement therebetween at the time of driving the spring rotor 40 along an arcuate path about the rotational axis O. Therefore, the double coil spring 50 can expand and contract linearly.

The rotational angle sensor 60 includes a sensing device 62 at one longitudinal end part 61 thereof. The rotational angle sensor 60 further includes a connector 63 at the other longitudinal end part thereof. The rotational angle sensor 60 is fitted into a groove 132, which is formed in the outer wall of the side plate 13. The one longitudinal end part 61 of the rotational angle sensor 60 is disposed in the bearing hole 131 of the side plate 13. A groove 33 is formed in the one axial end part 31 of the shaft member 30, which is adjacent to the side plate 13. The groove 33 is recessed toward the other axial end part 32 of the shaft member 30, at which the side plate 14 is located. The sensing device 62 projects from the one longitudinal end part 61 of the rotational angle sensor 60 toward the shaft member 30 and is received in the groove 33 of the shaft member 30.

Two permanent magnets, which are connected with each other through an undepicted yoke, are buried in the inner peripheral wall of the groove 33 of the shaft member 30. A direction of a magnetic field, which is generated by the permanent magnets and the yoke, changes depending on the rotational angle of the shaft member 30. The sensing device 62 includes Hall elements or magnetoresistive elements, which sense the magnetic field generated by the permanent magnets and the yoke that are radially spaced from and are radially opposed to the Hall elements or magnetoresistive elements.

The connector 63 (FIG. 2) includes terminals, which are buried in the resin of the connector 63 and are electrically connected to the sensing device 62. The output voltage, which is outputted from the sensing device 62, is outputted from the rotational angle sensor 60 to the ECU through the terminals. The output voltage is proportional to the amount of rotation (rotational angle) of the pedal member 20.

The friction washer 70 is configured into a generally planar arcuate disk and is placed between the spring rotor 40 and the side plate 14, and a plane of the friction washer 70 is generally perpendicular to the rotational axis O. The friction washer 70 includes two stubs 71, which project from the rest of the friction washer 70 in the axial direction of the rotational axis O away from the spring rotor 40. The stubs 71 are anchored between the inner wall of the notched hole 141 of the side plate 14 and the outer wall of the bearing portion 161 in a non-rotatable manner, so that the stubs 71 are non-rotatable relative to the side plate 14. The friction washer 70 further includes slidable contact portions 72, which are located at one axial side of the friction washer 70, at which the spring rotor 40 is placed. The slidable contact portions 72 project from the rest of the friction washer 70 toward the spring rotor 40 in the axial direction of the rotational axis O. A planar slidable contact surface 72a of each slidable contact portion 72 extends in an imaginary plane, which is generally perpendicular to the rotational axis O.

The slidable contact surface 72a of each slidable contact portion 72 slidably contacts a wall surface 40a of the spring rotor 40, which serves as a contact surface that slidably contacts the slidable contact surfaces 72a of the slidable contact portions 72. In the present embodiment, the wall surface 40a of the spring rotor 40 is formed as a planar axial end wall surface of an arcuate ridge, which projects from the rest of the spring rotor 40 toward the friction washer 70 in the axial direction of the rotational axis O. The wall surface 40a, which serves as the contact surface, may not be formed at a bottom side part of the arcuate ridge of the spring rotor 40, which is axially opposed to the bottom side part of the friction washer 70 where no slidable contact portion 72 is formed. However, the wall surface 40a, which serves as the contact surface, may be formed to extend to the bottom side part of the arcuate ridge of the spring rotor 40 as an annular contact surface (a ring shaped contact surface), if desired.

An engaging portion 73 of the friction washer 70, which is located at the other axial side of the friction washer 70 opposite from the slidable contact portions 72 in the axial direction of the rotational axis O, is engaged with the inner wall surface (contact surface) of the side plate 14 through an engaging surface 73a. Thereby, at the time of rotating the pedal member 20, the engaging portion 73 of the friction washer 70 is engaged with the side plate 14, and the slidable contact surfaces 72a of the slidable contact portions 72 slidably contact the wall surface 40a of the spring rotor 40. Thus, at the time of rotating the pedal member 20, a frictional force, which limits the rotational movement of the pedal member 20, is exerted between the slidable contact surfaces 72a of the slidable contact portions 72 and the wall surface 40a of the spring rotor 40.

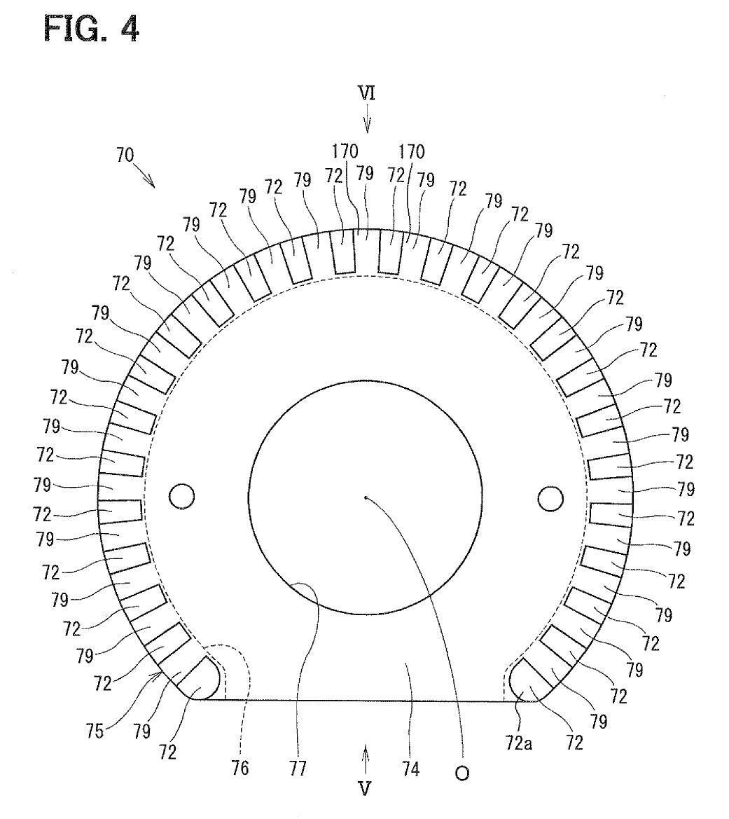

The structure of the friction washer 70 will be described in detail with reference to FIGS. 4 to 6.

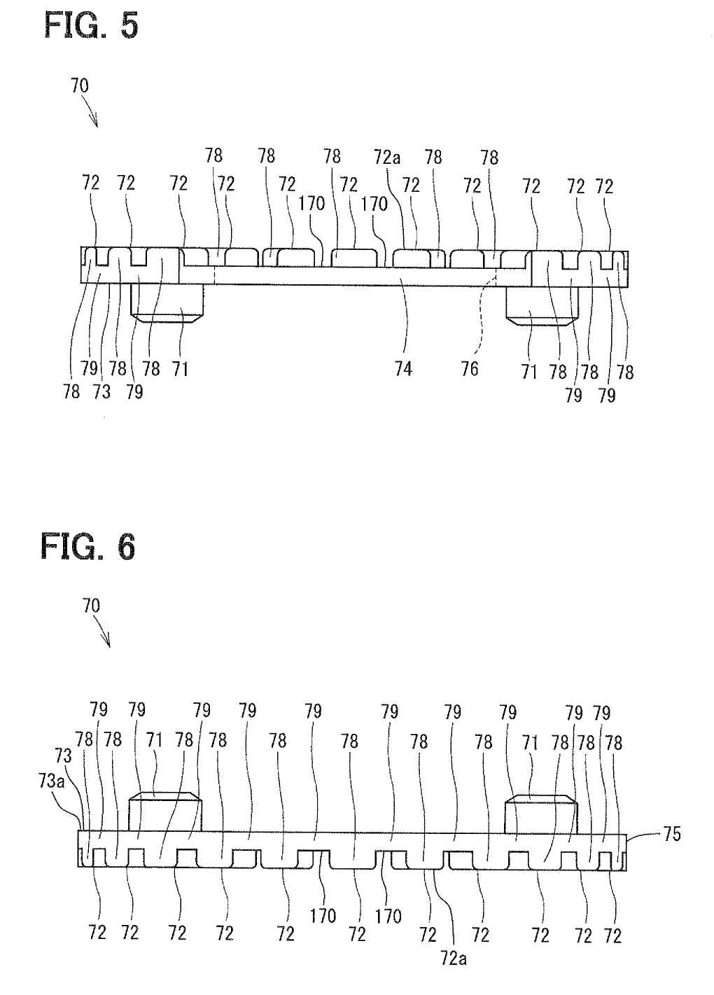

FIG. 4 is a view of the friction washer 70 taken from the one axial side of the friction washer 70, at which the spring rotor 40 is placed. FIG. 5 is a view of the friction washer 70 taken in a direction of an arrow V in FIG. 4, and FIG. 6 is a view of the friction washer 70 taken in a direction of an arrow VI in FIG. 4.

The friction washer 70 includes a fixing portion (stationary portion) 74, a resiliently deformable portion 75, the slidable contact portions 72 and the engaging portion 73 and is integrally molded, i.e., integrally formed from a resin material as a single piece. A dotted line 76 in FIG. 4 illustratively indicates a boundary between the fixing portion 74 and the resiliently deformable portion 75 for description purpose. Each of the resiliently deformable portion 75, the slidable contact portions 72 and the engaging portion 73 may serve as a displaceable portion that is displaceable in the circumferential direction relative to the fixing portion 74, which is substantially fixed with respect to its position, i.e., is non-rotatable.

The fixing portion 74 is configured into a generally planar annular form and is located radially outward of the rotational axis O. The fixing portion 74 includes a shaft hole 77 at a center of the fixing portion 74 to receive the shaft member 30 therethrough. The stubs 71 axially project from a wall of the fixing portion 74 at the other axial side of the fixing portion 74, which is opposite from the spring rotor 40 in the axial direction of the rotational axis O. These stubs 71 are diametrically opposed to each other about the rotational axis O. The fixing portion 74 is supported in a non-rotatable manner relative to the side plate 14 of the housing 10 through the stubs 71.

The resiliently deformable portion 75, which is resiliently deformable in the rotational direction of the spring rotor 40, is placed radially outward of the fixing portion 74 and is spaced from the rotational axis O by a constant distance (predetermined distance). In other words, the resiliently deformable portion 75 is placed along an imaginary arc, which has its center at the rotational axis O and has the radius of the predetermined distance discussed above. The resiliently deformable portion 75 includes a plurality of thin wall portions 79 and a plurality of thick wall portions 78. A wall thickness (plate thickness) of each thin wall portion 79, which is measured in a direction perpendicular to a plane of the fixing portion 74, i.e., in the axial direction of the rotational axis O, is generally the same as a wall thickness (plate thickness) of the fixing portion 74 measured in the direction perpendicular to the plane of the fixing portion 74. A wall thickness (plate thickness) of each thick wall portion 78, which is measured in the direction perpendicular to the plane of the fixing portion 74, is larger than that of the thin wall portion 79. The thick wall portion 78 projects from one axial end of its adjacent thin wall portion 79 on the one axial side of the fixing portion 74 toward the spring rotor 40. The thick wall portions 78 are arranged one after another at generally constant intervals in the circumferential direction of the friction washer 70 (the rotational direction of the pedal member 20) about the rotational axis O. Each thin wall portion 79 is axially recessed from one axial end (free end) of each adjacent thick wall portion 78 away from the spring rotor 40 in the axial direction of the rotational axis O. Furthermore, each thin wall portion 79 circumferentially interconnects between the adjacent thick wall portions 78, which are located on one circumferential side and the other circumferential side, respectively, of the thin wall portion 79 in FIG. 4. Thereby, a gap 170 in a form of an axial recess is circumferentially defined between each circumferentially adjacent two of the thick wall portions 78. A rigidity of the resiliently deformable portion 75 in the circumferential direction of the friction washer 70 (in the rotational direction of the pedal member 20) is determined based on, for example, the number of the thick wall portions 78, the number of the thin wall portions 79, the circumferential size of each thick wall portion 78, the circumferential size of each thin wall portion 79, the wall thickness of each thick wall portion 78 measured in the axial direction of the rotational axis O and the wall thickness of each thin wall portion 79 measured in the axial direction of the rotational axis O.

Axial end surfaces of the thick wall portions 78, which are located on the one axial side of the fixing portion 74 where the spring rotor 40 is located, form the slidable contact portions 72 (more specifically, the slidable contact surfaces 72a of the slidable contact portions 72), respectively. Each slidable contact portion 72 makes a surface contact with the wall surface 40a of the spring rotor 40 through the slidable contact surface 72a of the slidable contact portion 72. A circumferential extent of a radially outer end part (radially outer edge part) of each slidable contact portion 72, which is measured in the circumferential direction of the friction washer 70 (in the rotational direction of the pedal member 20), is larger than a circumferential extent of a radially inner end part (radially inner edge part) of the slidable contact portion 72, so that the slidable contact portion 72 is configured into a generally trapezoidal shape when viewed in the axial direction of the rotational axis O. Two opposed circumferential ends (circumferential edges) of each slidable contact portion 72, which are opposed to each other in the circumferential direction of the friction washer 70 (in the rotational direction of the pedal member 20), are chamfered to facilitate the smooth slide contact of the slidable contact portion 72 with the wall surface 40a of the spring rotor 40.

The engaging portion 73 is located on the other axial side of the fixing portion 74 and thereby of the thick wall portions 78, which is opposite from the spring rotor 40 in the axial direction of the rotational axis O, so that the engaging portion 73 makes a surface contact with the inner wall of the side plate 14 through the engaging surface 73a.

Next, the operation of the pedal apparatus 1 will be schematically described with reference to FIGS. 1 to 3 and 7.

In the state where the pedal member 20 is not depressed by the foot of the driver, i.e., is fully released, the pedal member 20 is urged by the double coil spring 50 in the opposite direction (releasing direction), which is opposite from the depressing direction. At this time, the engaging portion 231 of the pedal rotor 21 contacts the stopper 121 of the top plate 12.

When the pedal member 20 begins to rotate in the direction of the arrow X in FIG. 2 upon application of a pedal force (which is also referred to as a depressing force) against the pedal member 20 from the foot of the driver, the pedal rotor 21 and the spring rotor 40 are rotated together through the engagement between the bevel teeth 27 and the bevel teeth 43. The rotational angle sensor 60 senses the rotational angle of the shaft member 30, which is rotated integrally with the pedal rotor 21 based on the magnetic field generated from the permanent magnets and the yoke. The output voltage of the rotational angle sensor 60 is sent to the ECU through the connector 63.

When the amount of rotation of the pedal member 20 is increased upon further rotation of the pedal member 20 in the direction of the arrow X in FIG. 2 through the application of the pedal force against the pedal member 20, the double coil spring 50 is compressed to increase the resilient force applied to the pedal member 20. Thereby, the pedal force, which is applied against the pedal member 20 from the foot of the driver, is increased in proportion to the amount of rotation of the pedal member 20.

The pedal force of the driver and the resilient force of the double coil spring 50 cause generation of a thrust force between the bevel teeth 27 of the pedal rotor 21 and the bevel teeth 43 of the spring rotor 40 in the axial direction of the rotational axis O to displace the bevel teeth 27 and the bevel teeth 43 away from each other in the axial direction of the rotational axis O. This thrust force causes generation of a frictional force between the friction ring 24 of the pedal rotor 21 and the side plate 13 and also generation of a frictional force between the spring rotor 40 and the friction washer 70. Thereby, in proportional to the increase in the amount of rotation of the pedal member 20 in the direction of the arrow X, the pedal force and the resilient force of the double coil spring 50 are increased to cause the increase in the thrust force. As a result, the frictional force between the friction ring 24 of the pedal rotor 21 and the side plate 13 and the frictional force between the spring rotor 40 and the friction washer 70 are both increased. These frictional forces limit the rotational movement of the pedal member 20. Therefore, at the time of rotating the pedal member 20 in the direction of the arrow X, the pedal force of the driver is increased.

When the driver further depresses the pedal member 20 in the direction of the arrow X, the kick-down switch 25 contacts the stopper 111 of the bottom plate 11. Therefore, the rotation of the pedal member 20 is limited, i.e., is stopped.

In contrast, when the pedal member 20 is rotated in the direction of the arrow Y, the frictional forces act as interfering forces, which interfere the rotational movement of the pedal member 20, thereby resulting in the decrease in the pedal force of the driver.

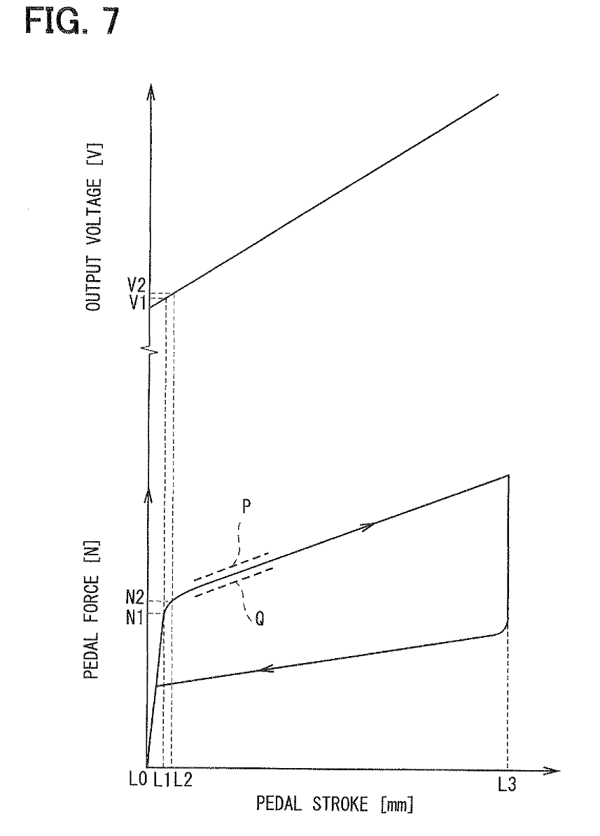

Therefore, as shown in FIG. 7, due to the above-described frictional forces, which vary depending on the amount of rotation of the pedal member 20, the pedal force of the driver at the time of rotating the pedal member 20 in the direction of the arrow X is different from the pedal force of the driver at the time of rotating the pedal member 20 in the direction of the arrow Y, thereby implementing the predetermined hysteresis characteristics of the pedal apparatus 1. In this way, the pedal apparatus 1 can provide an appropriate operational feeling to the driver.

Next, the pedal force characteristics at the time of starting the depressing movement of the pedal member 20 in the pedal apparatus 1 according to the present embodiment will be described. The description of the frictional force between the friction ring 24 and the side plate 13 is omitted for the sake of simplicity.

When the driver initially applies the pedal force against the pedal member 20, the pedal stroke of the pedal member 20 is slightly shifted from a point L0 to a point L1 due to, for example, the engagement between the corresponding components.

When the driver further increases the pedal force against the pedal member 20, a stress is generated in the resiliently deformable portion 75 to cause resilient deformation of the thick wall portions 78 in the rotational direction due to a static frictional force exerted between the spring rotor 40 and the slidable contact portions 72 at the time of shifting the pedal stroke from the point L1 to a point L2. Then, the state of each slidable contact portion 72 is shifted from the static state, in which the slidable contact portion 72 is displaced together with the spring rotor 40, i.e., is dragged by the spring rotor 40 in the rotational direction without making a relative movement between the slidable contact portion 72 and the spring rotor 40, to the sliding state, in which the slidable contact portion 72 slides on the wall surface 40a of the spring rotor 40. In this way, the pedal force is progressively increased from a force N1 to a force N2. When the pedal force is progressively increased from the force N1 to the force N2, the output voltage is progressively increased from a voltage V1 to a voltage V2.

When the pedal stroke is shifted from the point L2 to a point L3, the thick wall portions 78 are resiliently deformed in the rotational direction. Thereby, each of the slidable contact portions 72, which are provided to the thick wall portions 78, respectively, can slide on the wall surface 40a of the spring rotor 40 without causing a substantial change in the contact surface 72a, at which the slidable contact portion 72 and the wall of the spring rotor 40 slidably contact with each other. Thereby, as indicated by a dotted line P and a dotted line Q in FIG. 7, it is possible to limit the variation in the hysteresis characteristics, which would be induced by a physical change of the corresponding component caused by a long term use (or aging) or a physical change of the corresponding component caused by the temperature change.

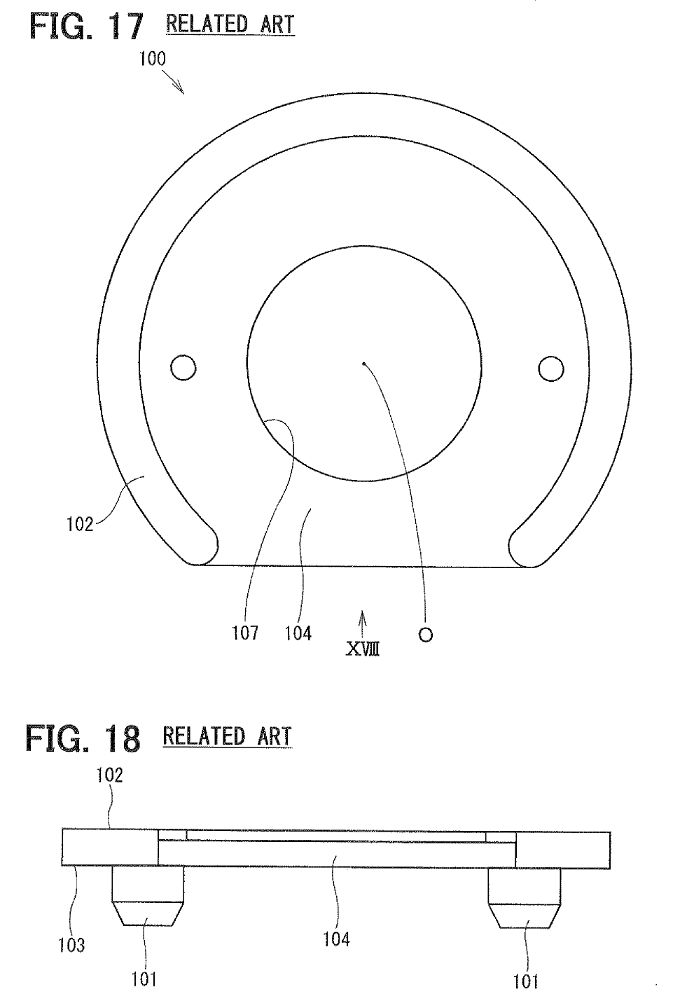

Next, a friction washer of a first comparative example will be described with reference to FIGS. 17 to 19 for illustrative purpose.

The friction washer 100 of the first comparative example is placed between an undepicted sprig rotor and a side wall of an undepicted housing. The friction washer 100 includes a fixing portion 104 and a slidable contact portion 102 and is integrally molded, i.e., integrally formed from a resin material as a single piece.

The fixing portion 104 is configured into an annular form and is placed radially outward of the rotational axis O. The fixing portion 104 includes a shaft hole 107, which extends through a center of the fixing portion 104 and receives a shaft member therethrough. Two stubs 101 project from a wall of the fixing portion 104 at the other axial side of the fixing portion 104, which is opposite from the spring rotor in the axial direction of the rotational axis O. The stubs 101 are diametrically opposed to each other about the rotational axis O. A radially outer end part of the fixing portion 104 projects toward the spring rotor.

The slidable contact portion 102 is provided to an axial end surface of the radially outer end part of the fixing portion 104, which projects toward the spring rotor. The slidable contact portion 102 is formed continuously in a predetermined circumferential extent in the circumferential direction of the friction washer 100 (the rotational direction of the spring rotor), so that the slidable contact portion 102 makes a surface contact with the wall surface of the spring rotor. An engaging portion 103 is formed in the fixing portion 104 at the other axial side of the fixing portion 104, which is opposite from the slidable contact portion. The engaging portion 103 is engaged with the side plate of the housing.

As discussed above, the engaging portion 103 is engaged with the side plate of the housing, and the slidable contact portion 102 slidably contacts the wall of the spring rotor. Therefore, when the pedal member is rotated, the slidable contact portion 102 slides on the wall surface of the spring rotor to generate the frictional force, which limits the rotational movement of the pedal member.

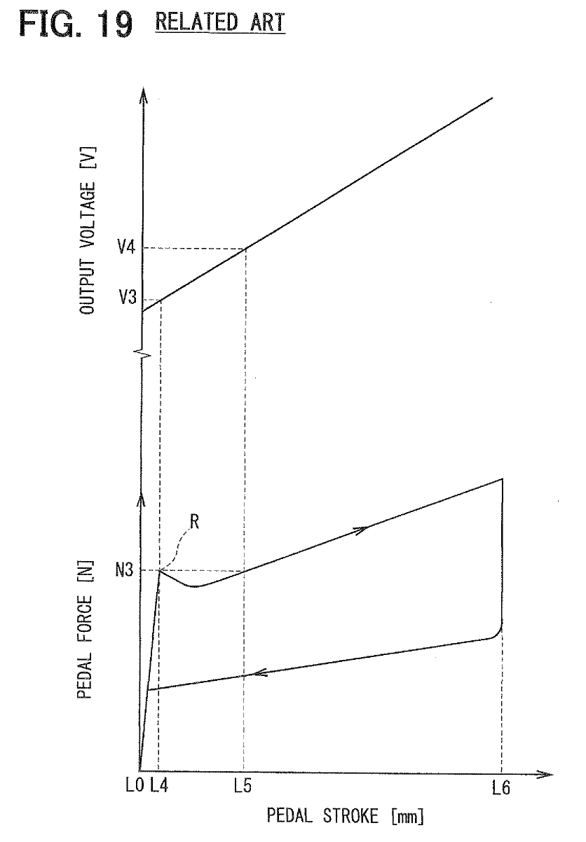

The pedal force characteristics, which are observed at the time of applying the friction washer 100 of the first comparative example, to the pedal apparatus, will be described with reference to FIG. 19.

When the driver applies the pedal force against the pedal member, the pedal stroke of the pedal member is slightly changed because of, for example, the engagement between the corresponding components. The static frictional force is exerted between the slidable contact portion 102 and the pedal rotor to maintain the static sate between the slidable contact portion 102 and the pedal rotor until the time point, at which the pedal stroke is changed from the point L0 to L4, and thereby the pedal force of the driver is increased to the force N3.

When the pedal force becomes larger than a resultant force of the maximum static frictional force between the slidable contact portion 102 and the pedal rotor and the resilient force of the double coil spring upon further increase of the pedal force applied from the driver against the pedal member, the slidable contact portion 102 and the pedal rotor is shifted from the static state to the sliding state.

When the slidable contact portion 102 and the pedal rotor are placed in the sliding state, the required pedal force, which is required to rotate the pedal member, is reduced due to a difference between the static frictional force and the kinetic frictional force. Therefore, at the time of starting the slide movement between the slidable contact portion 102 and the pedal rotor, a waveform of a pedal force graph shows the overshooting (spike), at which the pedal force is instantaneously increased. This overshooting of the pedal force (overshooting time pedal force) is indicated with R in FIG. 19.

The pedal stroke quickly changes to a point L5, at which the resultant force of the pedal force, the resilient force of the double coil spring and the kinetic frictional force between the slidable contact portion 102 and the pedal rotor becomes the pedal force N3, at which the peak of the overshooting of the pedal force has occurred. Therefore, the slip stroke is generated between the point L4 and the point L5.

The output voltage of the rotational angle sensor is instantaneously increased from the voltage V3 to the voltage V4 in proportional to the rotational angle of the pedal member during the time period of changing the pedal stroke from the point L4 to the point L5. Therefore, in the case of the first comparative example, the pedal apparatus may possibly cause an uncomfortable feeling of abrupt starting (or an uncomfortable feeling of abrupt acceleration) of the vehicle to the driver.

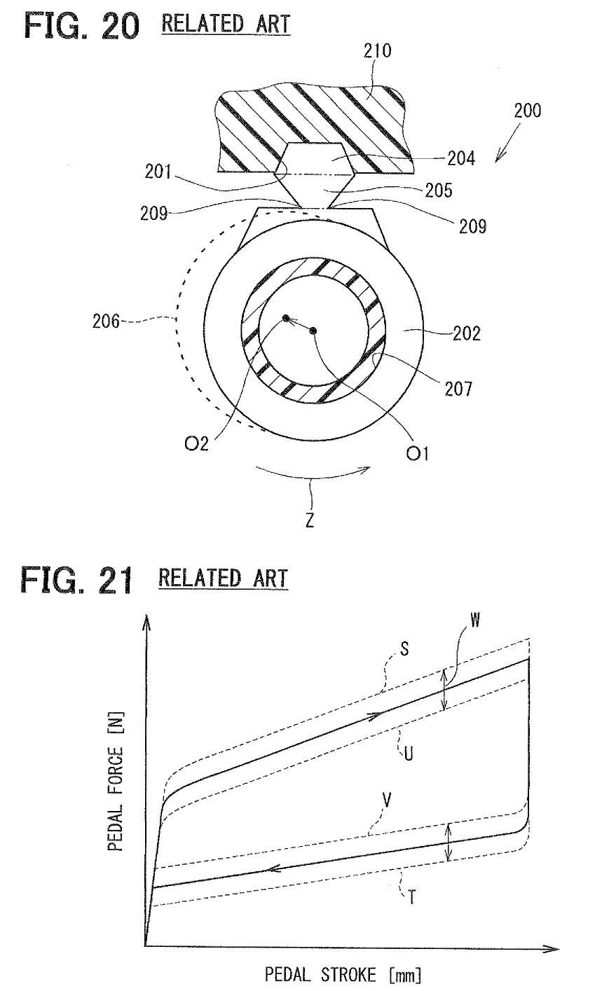

Next, a friction washer of a second comparative example will be described with reference to FIGS. 20 and 21.

The friction washer 200 of the second comparative example is molded, i.e., made from a resin material and includes a slidable contact portion 202, a fixing portion 204 and a resiliently deformable portion 205.

The slidable contact portion 202 is configured into an annular form and is placed radially outward of a rotational axis O1. The slidable contact portion 202 includes a shaft hole 207, which extends through a center of the slidable contact portion 202. The center of the slidable contact portion 202 coincides with the rotational axis O1 before start of the operation of the pedal apparatus. The slidable contact portion 202 makes a surface contact with a wall surface of an undepicted pedal rotor or an outer wall of an undepicted spring rotor.

The fixing portion 204 is placed radially outward of the slidable contact portion 202 and is connected to the slidable contact portion 202 through a resiliently deformable portion 205. The fixing portion 204 is anchored to a recess 201, which is formed in the housing 210. The resiliently deformable portion 205 connects between the slidable contact portion 202 and the fixing portion 204. The resiliently deformable portion 205 is resiliently deformably formed by forming two notched portions 209. Specifically, these two notched portions 209 are provided between a fixing portion 204 side of the resiliently deformable portion 205 and a slidable contact portion 202 side of the resiliently deformable portion 205.

When the driver applies the pedal force against the pedal member, the pedal member is rotated in a direction of an arrow Z in FIG. 20. At this time, the frictional force is generated between the slidable contact portion 202 and one of the pedal rotor and the spring rotor, so that the resiliently deformable portion 205 is resiliently deformed about the notched portions 209. Due to the physical change caused by the long term use or the physical change caused the temperature change, the center of the slidable contact portion 202 may possibly be displaced from the rotational axis O1 to the point 02 to cause displacement of the outer peripheral edge of the slidable contact portion 202 to the location indicated with a dotted line 206.

The pedal force characteristics, which are observed at the time of applying the friction washer 200 of the second comparative example to the pedal apparatus, will be described with reference to FIG. 21.

In the second comparative example, when the center and the outer peripheral edge of the slidable contact portion 202 are displaced, the contact surface, at which the slidable contact portion 202 and the one of the pedal rotor and the spring rotor slidably contact with each other, is changed. Thus, the coefficient of friction between the slidable contact portion 202 and the one of the pedal rotor and the spring rotor changes. Thereby, when the frictional force between the slidable contact portion 202 and the one of the pedal rotor and the spring rotor becomes larger than the frictional force between the slidable contact portion 202 and the one of the pedal rotor and the spring rotor before the operation of the pedal member, the hysteric characteristics become those indicated with dotted lines S, T in FIG. 21. In contrast, when the frictional force between the slidable contact portion 202 and the one of the pedal rotor and the spring rotor becomes smaller than the frictional force between the slidable contact portion 202 and the one of the pedal rotor and the spring rotor before the operation of the pedal member, the hysteric characteristics become those indicated with dotted lines U, V in FIG. 21. As discussed above, in the case of the second exemplary case, as indicated by double sided arrows W in FIG. 21, the pedal force may vary due to the physical change caused by the long term use or the physical change caused the temperature change. Therefore, it may be difficult to obtain the stable hysteric characteristics.

In the case of the first embodiment, the friction washer 70 includes the resiliently deformable portion 75 and the slidable contact portions 72, which are placed radially outward of the fixing portion 74 that is non-rotatably supported by the side plate 14 of the housing 10. The resiliently deformable portion 75 includes the thick wall portions 78, which are arranged one after another in the circumferential direction of the friction washer 70 (in the rotational direction of the pedal member 20), and the thin wall portions 79, each of which circumferentially interconnects between the adjacent thick wall portions 78. Thereby, at the time of starting the depressing movement of the pedal member 20, it is possible to reduce or minimize the pedal force overshooting, which would be present in the waveform of the pedal force graph when the state of each slidable contact portion 72 is changed from the static state to the sliding state. In this way, it is possible to limit the slip stroke, in which the pedal stroke is rapidly changed until the pedal force reaches the pedal force of the overshooting time once again. Therefore, the output voltage of the rotational angle sensor 60 is increased in response to the increase in the pedal force. Thereby, the pedal apparatus 1 can limit occurrence of the uncomfortable feeling of abrupt starting (or the uncomfortable feeling of abrupt acceleration) of the vehicle to the driver.

Furthermore, according to the present embodiment, each of the thick wall portions 78 can be resiliently deformable in the rotational direction of the pedal member 20, i.e., in the circumferential direction about the rotational axis O. In this way, each of the slidable contact portions 72 can slide on the wall surface 40a of the spring rotor 40 without causing the substantial change in the contact surface, at which the slidable contact portion 72 and the wall of the spring rotor 40 slidably contact with each other. Thus, it is possible to limit the change in the frictional force between the slidable contact portion 72 and the spring rotor 40 induced by the physical change of the corresponding component caused by the long term use (or aging) or the physical change of the corresponding component caused by the temperature change. As a result, the pedal apparatus 1 can provide the stable hysteric characteristics.

### Second Embodiment

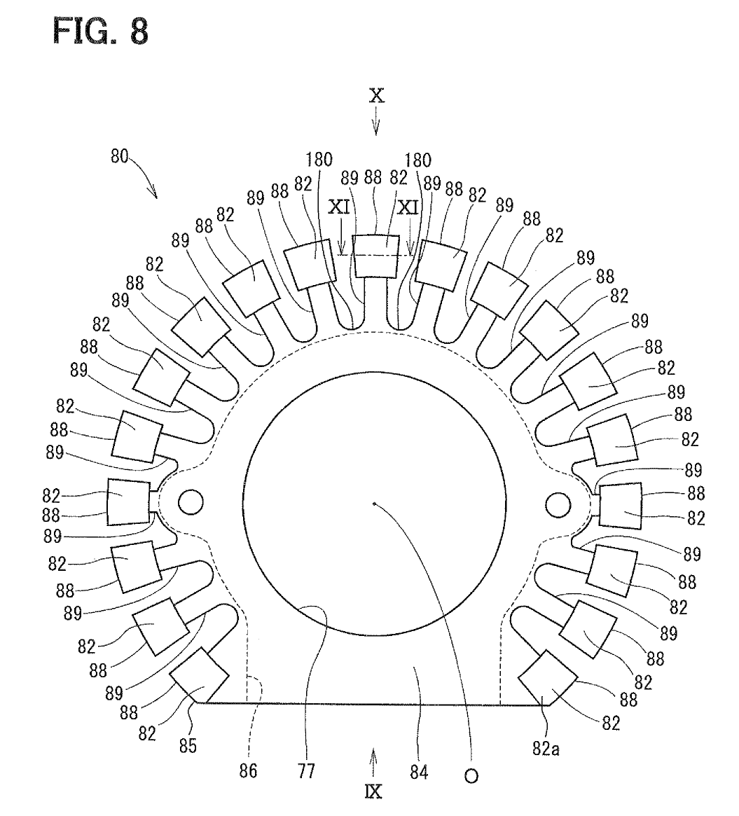

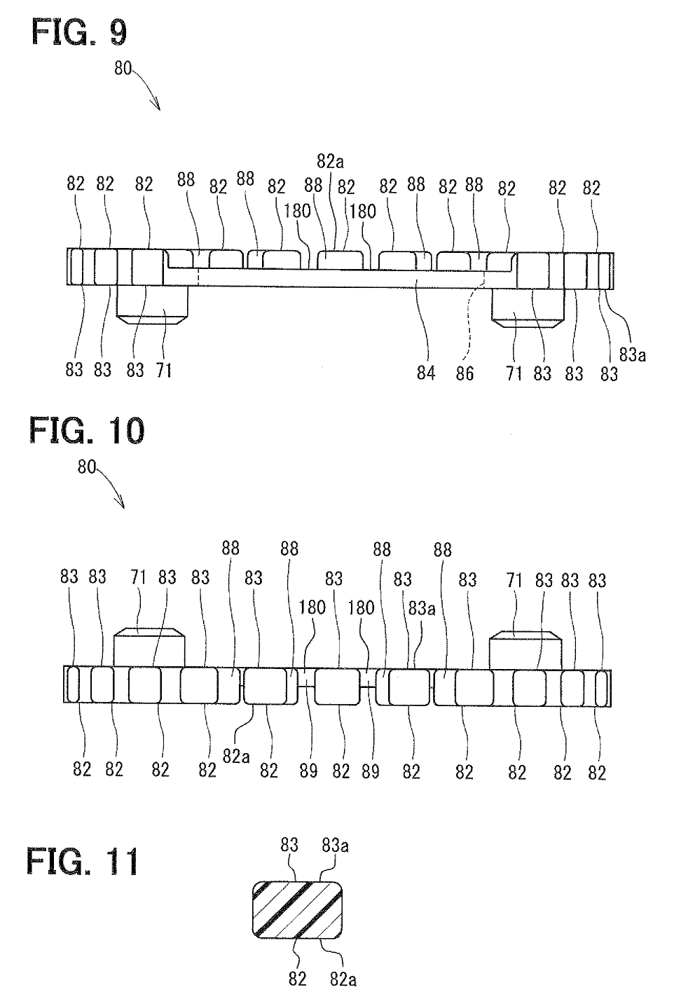

A friction washer used in the pedal apparatus according to a second embodiment of the present invention will be described with reference to FIGS. 8 to 11. In the following embodiments, the components, which are similar to those of the first embodiment, will be indicated by the same reference numerals and will not be described to avoid redundancy. Furthermore, since the remaining components of the pedal apparatus, which are other than the friction washer, are substantially the same as those of the first embodiment, these remaining components shown in FIGS. 1 to 3 will be also referred with the same reference numerals.

The friction washer (serving as a friction means or a friction device) 80 of the second embodiment is configured into a generally planar arcuate disk and is placed between the side plate 14 of the housing 10 and the spring rotor 40, and a plane of the friction washer 80 is generally perpendicular to the rotational axis O. The friction washer 80 generates the frictional force through the slide contact with the spring rotor 40 at the time of operation of the pedal member 20.

The friction washer 80 includes a fixing portion 84, a resiliently deformable portion 85, slidable contact portions 82 and engaging portions 83 and is integrally molded, i.e., integrally formed from a resin material as a single piece. A dotted line 86 in FIG. 8 illustratively indicates a boundary between the fixing portion 84 and the resiliently deformable portion 85 for description purpose. Each of the resiliently deformable portion 85, the slidable contact portions 82 and the engaging portions 83 may serve as a displaceable portion that is displaceable in the circumferential direction relative to the fixing portion 84.

The fixing portion 84 is configured into a generally planar annular form and is located radially outward of the rotational axis O of the pedal member 20. The two stubs 71 project from a wall of the fixing portion 84 at the other axial side of the fixing portion 84, which is opposite from the spring rotor 40 in the axial direction of the rotational axis O. These stubs 71 are diametrically opposed to each other about the rotational axis O.

The resiliently deformable portion 85 includes a plurality of arm portions (connecting portions) 89 and a plurality of head portions 88. Each of the arm portions 89 radially outwardly projects from the fixing portion 84, and a corresponding one of the head portions 88 is connected to a radially outer end part of the arm portion 89. Each arm portion 89 and its adjacent head portion 88 may serve as an individual resiliently deformable portion (individual resiliently deformable segment) of the resiliently deformable portion 85. The arm portions 89 are arranged one after another at generally equal intervals along the fixing portion 84 in the circumferential direction of the friction washer 80 (in the rotational direction of the pedal member 20) about the rotational axis O. A radial distance between the radially outer end part of each arm portion 89 and the rotational axis O is generally constant for all of the arm portions 89. A wall thickness (plate thickness) of each arm portion 89, which is measured in a direction perpendicular to a plane of the fixing portion 84, i.e., in the axial direction of the rotational axis O, is generally the same as a wall thickness (plate thickness) of the fixing portion 84 measured in the direction perpendicular to the plane of the fixing portion 84. Each circumferentially adjacent two of the arm portions 89 are interconnected at the fixing portion 84 to form a U-shape configuration. Thereby, a gap (slot) 180, which penetrates through the wall of the friction washer 80 in the axial direction of the rotational axis O, is circumferentially defined between each circumferentially adjacent two of the arm portions 89 and thereby between each circumferentially adjacent two of the head portions 88 (between slidable contact surfaces 82a of each circumferentially adjacent two of the slidable contact portions 82).

A circumferential extent of each head portion 88, which is measured in the circumferential direction of the friction washer 80 (in the rotational direction of the pedal member 20) about the rotational axis O, is set to be larger than a circumferential extent of each arm portion 89, which is measured in the circumferential direction of the friction washer 80 (in the rotational direction of the pedal member 20) about the rotational axis O. A wall thickness (plate thickness) of each head portion 88, which is measured in the direction perpendicular to the plane of the fixing portion 84, is larger than that of the arm portion 89. The head portion 88 projects from one axial end of its adjacent arm portion 89 on the one axial side of the fixing portion 84 toward the spring rotor 40. A radial distance between the radially outer end part of each head portion 88 and the rotational axis O is generally constant for all of the head portions 88. A rigidity of the resiliently deformable portion 85 in the circumferential direction of the friction washer 80 (the rotational direction of the pedal member 20) is determined based on, for example, the number of the arm portions 89, the number of the head portions 88, the radial size of each arm portion 89 and the wall thickness of each arm portion 89 measured in the axial direction of the rotational axis O.

Axial end surfaces of the head portions 88, which are located on the one axial side of the fixing portion 84 where the spring rotor 40 is located, form the slidable contact portions 82 (more specifically, the slidable contact surfaces 82a of the slidable contact portions 82), respectively. Each slidable contact portion 82 makes a surface contact with the wall surface 40a of the spring rotor 40 through the slidable contact surface 82a of the slidable contact portion 82. The engaging portions 83 are located on the other axial side of the fixing portion 84 and thereby of the head portions 88, which is opposite from the spring rotor 40 (opposite from the slidable contact surfaces 82a) in the axial direction of the rotational axis O, so that each of the engaging portions 83 makes a surface contact with the inner wall (contact surface) of the side plate 14 through an engaging surface 83a thereof.

In the present embodiment, the resiliently deformable portion 85 of the friction washer 80 includes the arm portions 89, each of which radially outwardly projects from the fixing portion 84, and the head portions 88, each of which is connected to the radially outer end part of the corresponding one of the arm portions 89. The circumferential extent of each arm portion 89, which is measured in the circumferential direction of the friction washer 80 (the rotational direction of the pedal member 20), is set to be smaller than a circumferential extent of each head portion 88, which is measured in the circumferential direction of the friction washer 80 (the rotational direction of the pedal member 20), so that the resilient deformation of the head portions 88 in the circumferential direction of the friction washer 80 (the rotational direction of the pedal member 20) is eased. Thus, each of the head portions 88 is resiliently deformable independently from, i.e., is displaceable independently from its circumferentially adjacent head portion 88 in the circumferential direction of the friction washer 80 (the rotational direction of the pedal member 20) at the axial location between the spring rotor 40 and the side plate 14 of the housing 10. In this way, the slidable contact portions 82, which are provided to the head portions 88, respectively, can smoothly slide on the wall surface 40a of the spring rotor 40 synchronously with the rotation of the pedal member 20. Thereby, at the time of starting the depressing movement of the pedal member 20, it is possible to reduce or minimize the pedal force overshooting, which would be present in the waveform of the pedal force graph.

### Third Embodiment

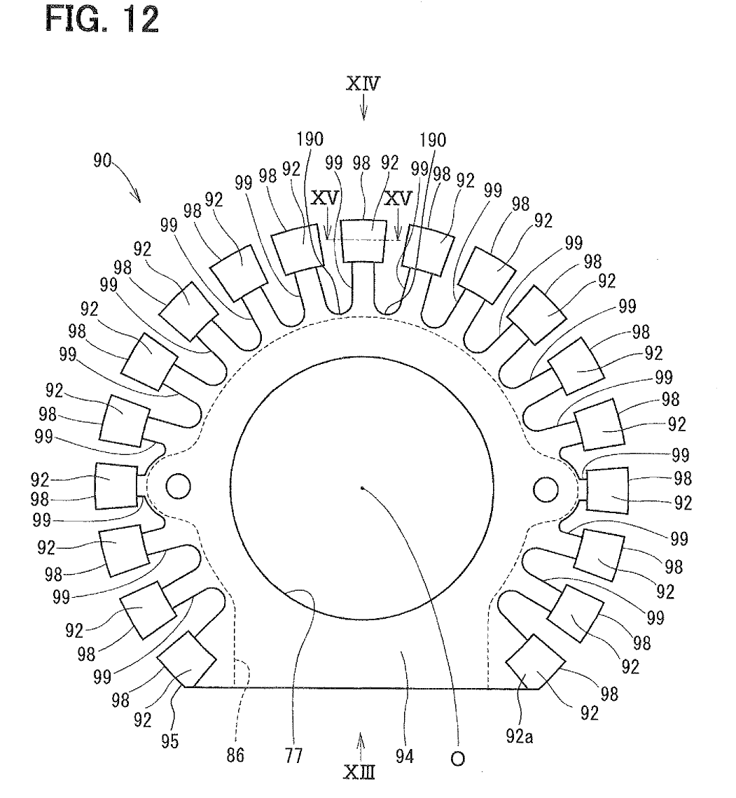

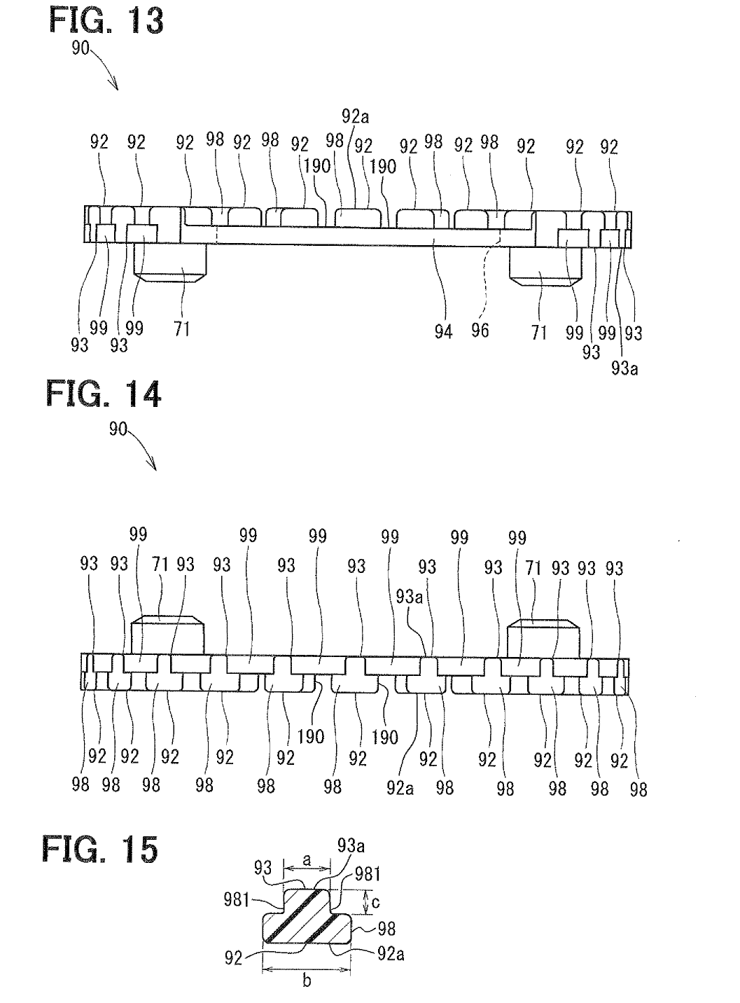

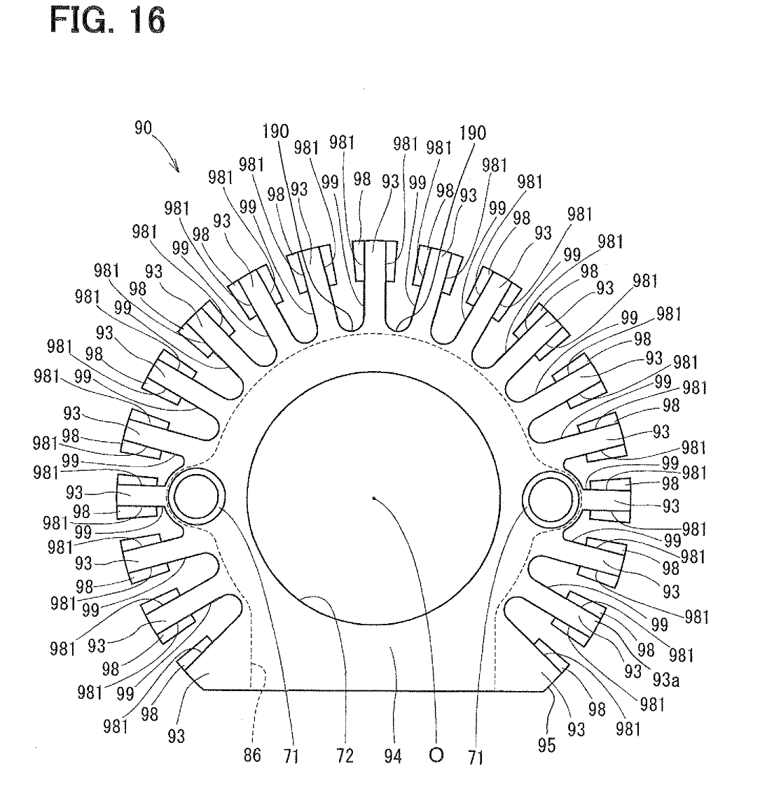

A friction washer used in the pedal apparatus according to a third embodiment of the present invention will be described with reference to FIGS. 12 to 16. The present embodiment is a modification of the second embodiment, and a friction washer (serving as a friction means or a friction device) 90 of the present embodiment is configured into a generally planar arcuate disk and is placed between the spring rotor 40 and the side plate 14 of the housing 10, and a plane of the friction washer 90 is generally perpendicular to the rotational axis O. The friction washer 90 exerts the frictional force against the rotational movement of the pedal member 20.

The friction washer 90 includes a fixing portion 94, a resiliently deformable portion 95, slidable contact portions 92 and engaging portions 93 and is integrally molded, i.e., integrally formed from a resin material as a single piece. A dotted line 86 in FIG. 12 illustratively indicates a boundary between the fixing portion 94 and the resiliently deformable portion 95 for description purpose. Each of the resiliently deformable portion 95, the slidable contact portions 92 and the engaging portions 93 may serve as a displaceable portion that is displaceable in the circumferential direction relative to the fixing portion 94. A gap (slot) 190, which penetrates through the wall of the friction washer 90 in the axial direction of the rotational axis O, is circumferentially defined between each circumferentially adjacent two of arm portions 99 and thereby between each circumferentially adjacent two of the head portions 98 (between slidable contact surfaces 92a of each circumferentially adjacent two of the slidable contact portions 92). Furthermore, each arm portion 99 and its adjacent head portion 98, which are radially connected together, may serve as an individual resiliently deformable portion (individual resiliently deformable segment) of the resiliently deformable portion 95.

In the friction washer 90, two recesses 981 (FIG. 15) are provided on one circumferential side and the other circumferential side, respectively, of each of the head portions 98 provided in the resiliently deformable portion 95. These two recesses 981 are provided on the other axial side of each corresponding one of the head portions 98 opposite from the spring rotor 40 in the axial direction of the rotational axis O. Each recess 981 is recessed from the engaging surface 93a of the engaging portion 93 toward the spring rotor 40 in the axial direction of the rotational axis O. As discussed above, these two recesses 981 are provided on the one circumferential side and the other circumferential side, respectively, of the corresponding head portion 98. Thereby, each engaging portion 93 (more specifically, an engaging surface 93a of the engaging portion 93 engaged with the wall surface of the side plate 14), which is provided to the corresponding head portion 98, has a circumferential extent “a” that is measured in the circumferential direction of the friction washer 90 and is smaller than a circumferential extent “b” of each slidable contact portion 92 (more specifically, the slidable contact surface 92a of the slidable contact portion 92) that is measured in the circumferential direction of the friction washer 90 (see FIG. 15). The function of the engaging portion 93 and the function of the slidable contact portion 92 are similar to the function of the engaging portion 83 and the function of the slidable contact portion 82, respectively, of the second embodiment.

The circumferential extent “a” of the engaging portion 93 is substantially the same as that of the arm portion (connecting portion) 99. An axial extent “c” (depth) of each recess 981, which is measured from the adjacent engaging surface 93a in the axial direction of the rotational axis O, is generally the same as an axial extent of each arm portion 99, which is measured in the axial direction of the rotational axis O. Therefore, the arm portion 99 and the adjacent engaging portion 93 are continuously formed in the radial direction while maintaining the constant cross-sectional area (the constant cross-sectional shape) along generally the entire radial extent of the arm portion 99 and the engaging portion 93.

In the third embodiment, a surface area of the engaging surface 93a of each engaging portion 93, which engages the wall surface of the side plate 14 of the housing 10, is set to be smaller than a surface area of the slidable contact surface 92a of each slidable contact portion 92, which slidably contacts the wall surface 40a of the spring rotor 40. Thereby, a surface pressure, which is exerted between the wall surface of the side plate 14 of the housing 10 and the engaging surface 93a of the engaging portion 93, is different from a surface pressure, which is exerted between the wall surface 40a of the spring rotor 40 and the slidable contact surface 92a of the slidable contact portion 92. In this way, the state of the engaging surface 93a of each engaging portion 93 and the wall surface of the side plate 14 of the housing 10 can be shifted from the static state to the sliding state before or after the occurrence of shifting of the state of the slidable contact surface 92a of each slidable contact portion 92 and the wall surface 40a of the spring rotor 40 from the static state to the sliding state. Therefore, it is possible to reduce or minimize the pedal force overshooting and thereby to reduce or minimize the slip stroke.

Furthermore, each arm portion 99 and the adjacent engaging portion 93 are continuously formed in the radial direction while maintaining the constant cross-sectional area (the constant cross-sectional shape) along generally the entire radial extent of the arm portion 99 and the engaging portion 93. Thereby, the resilient deformation of the head portion 98 in the circumferential direction of the friction washer 90 (the rotational direction of the pedal member 20) is eased, so that the slidable contact surface 92a of the slidable contact portion 92 can be easily slid on the wall surface 40a of the spring rotor 40 in the circumferential direction (the rotational direction of the pedal member 20). In this way, the stable hysteric characteristics of the pedal apparatus 1 can be obtained. As a result, the operational feeling of the pedal member can be improved.

Now, modifications of the above embodiments will be described.

In the above embodiments, the plate thickness of the fixing portion 74, 84, 94 is made generally the same as the plate thickness of the thin wall portion 79 or the arm portion 89, 99. Furthermore, the thick wall portion 78 or the head portion 88, 98 is projected from the thin wall portion 79 or the arm portion 89, 99 in the axial direction of the rotational axis O. Alternative to this construction, the plate thickness of the fixing portion may be made generally the same as the plate thickness of the thick wail portion or the head portion, and the thin wall portion or the arm portion may be recessed from the thick wall portion or the head portion in the axial direction of the rotational axis O.

In the above embodiments, the friction washer 70, 80, 90 is supported by the side plate 14 of the housing 10 and is slid over wall surface 40a of the spring rotor 40. Alternatively, the friction washer may be configured such that the friction washer is supported by the other side plate 13 of the housing 10 and is slid on the wall surface of the pedal rotor 21. Further alternatively, the friction washer may be supported by the spring rotor 40, the pedal rotor 21 or the shaft member 30 and may be slid on the wall surface of one of the side plates 13, 14 of the housing 10.

Further alternatively, the fixing portion may be placed radially outward of the resiliently deformably portion, so that the slidable contact portions may be placed radially inward of the fixing portion. Also, the pedal apparatus of the present invention is not limited to the accelerator pedal apparatus and may be implemented as a pedal apparatus of another kind (e.g., a brake pedal), if desired.

As discussed above, the present invention is not limited to the above embodiments, and the above embodiments may be modified within the spirit and scope of the invention.

1. A pedal apparatus comprising:
a support member that is installable to a body of a vehicle;
a pedal member that is rotatably supported by the support member and is adapted to be depressed in a depressing direction by a driver of the vehicle;
an urging means for urging the pedal member in an opposite rotational direction, which is opposite from the depressing direction of the pedal member, wherein one end part of the urging means is anchored to the support member; and
a friction means for applying a frictional force against rotational movement of the pedal member, wherein the friction means is placed between the support member and the pedal member, and at least a portion of the friction means is rotated by a predetermined amount together with the pedal member when the pedal member is rotated.

2. The pedal apparatus according to claim 1, wherein:
the at least the portion of the friction means includes a slidable contact portion; and
the friction means includes:
a fixing portion that is supported by one of the support member and the pedal member, wherein the slidable contact portion is placed radially outward of the fixing portion in a radial direction of a rotational axis of the pedal member and slidably contacts the other one of the support member and the pedal member; and
a resiliently deformable portion that is placed between the fixing portion and the slidable contact portion and is resiliently deformable in a rotational direction of the pedal member.

3. The pedal apparatus according to claim 2, wherein the slidable contact portion is one of a plurality of slidable contact portions of the friction means, which are arranged one after another in the rotational direction of the pedal member.

4. The pedal apparatus according to claim 2, wherein the resiliently deformable portion includes:
a plurality of thick wall portions, which are arranged one after another in the rotational direction of the pedal member; and
at least one thin wall portion, which has a wall thickness smaller than that of each of the plurality of thick wall portions in an axial direction of the rotational axis and connects between corresponding adjacent two of the plurality of thick wall portions.

5. The pedal apparatus according to claim 2, wherein the resiliently deformable portion is one of a plurality of resiliently deformable portions of the friction means, which radially outwardly project from the fixing portion and are arranged one after another in the rotational direction of the pedal member.

6. The pedal apparatus according to claim 5, wherein:
the friction means includes a plurality of engaging portions, each of which is located on an opposite axial side of a corresponding one of the plurality of resiliently deformable portions that is opposite from the slidable contact portion in the axial direction of the rotational axis;
each of the plurality of engaging portions is engageable with the one of the support member and the pedal member; and
an extent of each of the plurality of engaging portions in the rotational direction is smaller than that of the slidable contact portion.

7. The pedal apparatus according to claim 1, wherein:
the urging means is an urging device;
the friction means is a friction device;
the friction device includes a fixing portion, which is supported by and is non-rotatable relative to one of the support member and the pedal member;
the at least the portion of the friction device includes a plurality of slidable contact portions, each of which is connected to the fixing portion in a radial direction of the rotational axis and has a slidable contact surface that slidably contacts a contact surface of the other one of the support member and the pedal member;
each of the plurality of slidable contact portions is adapted to be displaced relative to the fixing portion by the predetermined amount in a circumferential direction about a rotational axis of the pedal member upon rotation of the pedal member; and
the slidable contact surfaces of each circumferentially adjacent two of the plurality of slidable contact portions are discontinuous from each other along the contact surface of the other one of the support member and the pedal member in the circumferential direction.

8. The pedal apparatus according to claim 7, wherein the slidable contact surfaces of each circumferentially adjacent two of the plurality of slidable contact portions are spaced from each other along the contact surface of the other one of the support member and the pedal member in the circumferential direction by a corresponding circumferential gap, which is an axial recess that is axially recessed from the slidable contact surfaces of the circumferentially adjacent two of the plurality of slidable contact portions in the axial direction of the rotational axis toward the one of the support member and the pedal member.

9. The pedal apparatus according to claim 7, wherein the slidable contact surfaces of each circumferentially adjacent two of the plurality of slidable contact portions are spaced from each other along the contact surface of the other one of the support member and the pedal member in the circumferential direction by a corresponding circumferential gap, which penetrates through a wall of the friction device in the axial direction of the rotational axis.

10. The pedal apparatus according to claim 7, wherein each circumferentially adjacent two of the plurality of slidable contact portions are displaceable independently from each other in the circumferential direction.

11. The pedal apparatus according to claim 7, wherein:
the fixing portion is supported by and is non-rotatable relative to the support member; and
the slidable contact surface of each of the plurality of slidable contact portions slidably contacts the contact surface of the pedal member.

12. The pedal apparatus according to claim 7, wherein:
the friction device is integrally formed as a single piece; and
the slidable contact surfaces of the plurality of slidable contact portions extend in an imaginary plane, which is generally perpendicular to the rotational axis of the pedal member.

13. The pedal apparatus according to claim 7, wherein:
the friction device further includes a plurality of engaging portions, each of which is located on an opposite axial side of a corresponding one of the plurality of slidable contact portions that is opposite from the slidable contact surface of the slidable contact portion in the axial direction of the rotational axis;
each of the plurality of engaging portions is engageable with a contact surface of the one of the support member and the pedal member through an engaging surface of the engaging portion; and
a circumferential extent of the engaging surface of each engaging portion in the circumferential direction about the rotational axis is different from that of the slidable contact surface of the slidable contact portion.

14. The pedal apparatus according to claim 13, wherein the circumferential extent of the engaging surface of each engaging portion in the circumferential direction about the rotational axis is smaller than that of the slidable contact surface of the slidable contact portion.
